(19) United States
(12) Patent Application Publication
(10) Pub. No.: US 2004/0265172 A1
(43) Pub. Date: Dec. 30, 2004

(54) Method and apparatus for entry and storage of specimens into a microfluidic device

(76) Inventors: Michael J. Pugia, Granger, IN (US); James A. Profitt, Goshen, IN (US); Gert Blankenstein, Dortmund (DE); Ralf-Peter Peters, Bergisch Gladbach (DE)

Correspondence Address: Elizabeth A. Levy, Bayer HealthCare LLC, 63 North Street, Medfield, MA, 02052, US

(21) Appl. No.: 10/608,671

(22) Filed: Jun. 27, 2003

(51) Int. Cl. G01N 1/10

(52) U.S. Cl. 422/58; 436/180

(57) ABSTRACT

A microfluidic device for analyzing biological samples is provided with a sample inlet section including an inlet port, a capillary passageway communicating with the inlet port and with an inlet chamber. The inlet chamber includes means for uniformly distributing the sample liquid across the inlet chamber and purging the air initially contained therein.

### BACKGROUND OF THE INVENTION

This invention relates to microfluidic devices, particularly those that are used for analysis of biological samples. Microfluidic devices are intended to be used for rapid analysis, thus avoiding the delay inherent in sending biological samples to a central laboratory. Such devices are intended to accept very small samples of blood, urine, and the like. The samples are brought into contact with reagents capable of indicating the presence and quantity of analytes found in the sample.

Many devices have been suggested for carrying out analysis near the patient, some of which will be discussed below. In general, such devices use only small samples, typically 0.1 to 200 μL. With the development of microfluidic devices the samples have become smaller, which is a desirable feature of their use. However, smaller samples introduce difficult problems. In microfluidic devices small samples, typically about 0.1 to 20 μL, are brought into contact with one or more wells where the samples are prepared for later analysis or reacted to indicate the presence (or absence) of an analyte. As the sample is moved into a well, it is important that the liquid is uniformly distributed and that all the air in the well is expelled, since air will adversely affect the movement of liquid and the analytical results. Other problems are associated with the initial introduction of the sample to the microfluidic device.

At first, the inlet port of such devices contains air, which must be expelled. A small amount of liquid must be deposited under conditions which force air out, but leave the sample in the inlet port and not on the surface of the device. Specimens on the surface will cause carry-over and contamination between analysis. Air in the port will cause underfilling and under estimation of the analytical results. Air bubbles in the inlet port or the receiving inlet chamber might interfere with the further liquid handling, especially if lateral capillary flow is used for further flow propulsion. One solution is to seal the inlet port to a pipette containing the sample liquid so that a plunger in the pipette can apply pressure to the inlet port. The flow through a capillary extending from the inlet port to the first well must be smooth so that air bubbles do not form in the capillary or in the entry to the first well. As the capillary enters the first well, the liquid should be distributed evenly as the passageway widens into the well. Here also, the movement of the liquid must be controlled so that air is moved ahead of the liquid and expelled through a vent passage.

While the sample may be directed immediately to a well containing reagents, it often will be sent initially to a well used to define the amount of the sample which will later be sent to other wells for preparation of the sample for subsequent contact with reagents. Where the first well is a metering well it is important that the well be completely filled, preferably with excess liquid passing out into an overflow well. Again, precision in metering requires that all the air originally in the well be expelled. Thus, the flow of the sample liquid should prevent trapping of air.

The present invention has been developed to overcome the problems discussed above and to assure that a microfluidic device including an improved inlet port of the invention provides accurate and repeatable results and allow containment and protection from under and overfilling.

### SUMMARY OF THE INVENTION

The invention relates in particular to entry ports adapted to supply small samples of 0.1 to 20 μL to microfluidic chips, thereby making possible accurate and repeatable assays of the analytes of interest in such samples. Such entry ports provide access for small samples and transfer of the samples uniformly into an inlet chamber while purging air from the microfluidic chip. Uniform distribution of the sample may be done by including grooves or weirs across the inlet chamber, which may contain wedge-shaped cutouts or other features to assist in distributing flow of the sample uniformly.

In some embodiments, the microfluidic chip will include an overflow chamber containing an indicator to assure complete filling of the inlet chamber.

### BRIEF DESCRIPTION OF THE DRAWINGS

FIG. 1 illustrates a portion of a microfluidic chip for determination of glucose in 50 samples.

FIG. 2 shows a cross-sectional view of the microfluidic chip of FIG. 1.

FIG. 3 illustrates a group of inlet ports.

FIG. 4 shows a microfluidic disk for analysis of urine.

FIG. 5 shows a microfluidic chip for immuno analysis.

### DESCRIPTION OF THE PREFERRED EMBODIMENTS

Flow in Microchannels

The microfluidic devices of the invention typically use smaller channels than have been proposed by previous workers in the field. In particular, the channels used in the invention have widths in the range of about 10 to 500 μm, preferably about 20-100 μm, whereas channels an order of magnitude larger have typically been used by others when capillary forces are used to move fluids. The minimum dimension for such channels is believed to be about 5 μm since smaller channels may effectively filter out components in the sample being analyzed. Channels in the range preferred in the invention make it possible to move liquid samples by capillary forces alone. It is also possible to stop movement by capillary walls that have been treated to become hydrophobic relative to the sample fluid. The resisting capillary forces can be overcome by a pressure difference, for example, by applying centrifugal force, pumping, vacuum, electroosmosis, heating, or additional capillary force. As a result, liquids can be metered and moved from one region of the device to another as required for the analysis being carried out.

A mathematical model has been derived which relates the centrifugal force, the fluid physical properties, the fluid surface tension, the surface energy of the capillary walls, the capillary size and the surface energy of particles contained in fluids to be analyzed. It is possible to predict the flow rate of a fluid through the capillary and the desired degree of hydrophobicity or hydrophilicity. The following general principles can be drawn from the relationship of these factors.

For any given passageway, the interaction of a liquid with the surface of the passageway may or may not have a significant effect on the movement of the liquid. When the surface to volume ratio of the passageway is large i.e. the cross-sectional area is small, the interactions between the liquid and the walls of the passageway become very significant. This is especially the case when one is concerned with passageways with nominal diameters less than about 200 μm, when capillary forces related to the surface energies of the liquid sample and the walls predominate. When the walls are wetted by the liquid, the liquid moves through the passageway without external forces being applied. Conversely, when the walls are not wetted by the liquid, the liquid attempts to withdraw from the passageway. These general tendencies can be employed to cause a liquid to move through a passageway or to stop moving at the junction with another passageway having a different cross-sectional area. If the liquid is at rest, then it can be moved by a pressure difference, such as by applying centrifugal force. Other means could be used, including air pressure, vacuum, electroosmosis, heating and the like, which are able to induce the needed pressure change at the junction between passageways having different cross-sectional areas or surface energies. In the present invention the passageways through which liquids move are smaller than have been used heretofore. This results in higher capillary forces being available and makes it possible to move liquids by capillary forces alone, without requiring external forces, except for short periods when a capillary stop must be overcome. However, the smaller passageways inherently are more likely to be sensitive to obstruction from particles in the biological samples or the reagents. Consequently, the surface energy of the passageway walls is adjusted as required for use with the sample fluid to be tested, e.g. blood, urine, and the like. This feature allows more flexible designs of analytical devices to be made. The devices can be smaller than the disks that have been used in the art and can operate with smaller samples. However, using smaller samples introduces new problems that are overcome by the present invention. One such problem is associated with the introduction of small samples in such a way that the device is filled uniformly and air is purged. Air trapped in the device can lead to underfilling or can block or interfere with all liquid handling steps further downstream related to the liquid transport in general, especially valving of liquids by capillary stops while overfilling can lead to carry-over. The ability to have proper filling and to detect whether improper filing occurs is required for accurate analysis.

Microfluidic Analytical Devices

The analytical devices of the invention may be referred to as “chips”. They are generally small and flat, typically about 1 to 2 inches square (25 to 50 mm square) or disks having a radius of about 40 to 80 mm. The volume of samples will be small. For example, they will contain only about 0.1 to 10 μL for each assay, although the total volume of a specimen may range from 10 to 200 μL. The wells for the sample fluids will be relatively wide and shallow in order that the samples can be easily seen and changes resulting from reaction of the samples can be measured by suitable equipment. The interconnecting capillary passageways will have a width in the range of 10 to 500 μm, preferably 20 to 100 μm, and the shape will be determined by the method used to form the passageways. The depth of the passageways should be at least 5 μm.

While there are several ways in which the capillaries and sample wells can be formed, such as injection molding, laser ablation, diamond milling or embossing, it is preferred to use injection molding in order to reduce the cost of the chips. Generally, a base portion of the chip will be cut to create the desired network of sample wells and capillaries and then, after reagent compounds have been placed in the wells as desired, a top portion will be attached over the base to complete the chip.

The chips are intended to be disposable after a single use. Consequently, they will be made of inexpensive materials to the extent possible, while being compatible with the reagents and the samples which are to be analyzed. In most instances, the chips will be made of plastics such as polycarbonate, polystyrene, polyacrylates, or polyurethene, alternatively, they can be made from silicates, glass, wax or metal.

The capillary passageways will be adjusted to be either hydrophobic or hydrophilic, properties which are defined with respect to the contact angle formed at a solid surface by a liquid sample or reagent. Typically, a surface is considered hydrophilic if the contact angle is less than 90 degrees and hydrophobic if the contact angle is greater than 90°. Preferably, plasma induced polymerization is carried out at the surface of the passageways. The analytical devices of the invention may also be made with other methods used to control the surface energy of the capillary walls, such as coating with hydrophilic or hydrophobic materials, grafting, or corona treatments. It is preferred that the surface energy of the capillary walls is adjusted, i.e. the degree of hydrophilicity or hydrophobicity, for use with the intended sample fluid. For example, to prevent deposits on the walls of a hydrophobic passageway or to assure that none of the liquid is left in a passageway. For most passageways in the present invention the surface is generally hydrophilic since the liquid tends to wet the surface and the surface tension forces causes the liquid to flow in the passageway. For example, the surface energy of capillary passageways can be adjusted by known methods so that the contact angle of water is between 10° to 60° when the passageway is to contact whole blood or a contact angle of 25° to 80° when the passageway is to contact urine.

Movement of liquids through the capillaries typically is prevented by capillary stops, which, as the name suggests, prevent liquids from flowing through the capillary.

If the capillary passageway is hydrophilic and promotes liquid flow, then a hydrophobic capillary stop can be used, i.e. a smaller passageway having hydrophobic walls. The liquid is not able to pass through the hydrophobic stop because the combination of the small size and the non-wettable walls results in a surface tension force which opposes the entry of the liquid. Alternatively, if the capillary is hydrophobic, no stop is necessary between a sample well and the capillary. The liquid in the sample well is prevented from entering the capillary until sufficient force is applied, such as by centrifugal force, to cause the liquid to overcome the opposing surface tension force and to pass through the hydrophobic passageway. It is a feature of the present invention that the force is only needed to start the flow of liquid when stopped within the device. Once the walls of the hydrophobic passageway are fully in contact with the liquid, the opposing force is reduced because presence of liquid lowers the energy barrier associated with the hydrophobic surface. Consequently, the liquid no longer requires force in order to flow. While not required, it may be convenient in some instances to continue applying force while liquid flows through the capillary passageways in order to facilitate rapid analysis. Centrifugal force, absorbent materials and air or liquid vacuum and pressure can be used to maintain fluidic flow. Flow can be started by capillary forces with or without the assistance of a pressure difference.

When the capillary passageways are hydrophilic, a sample liquid (presumed to be aqueous) will naturally flow through the capillary without requiring additional force. If a capillary stop is needed, one alternative is to use a narrower hydrophobic section which can serve as a stop as described above. A hydrophilic stop can also be used, even through the capillary is hydrophilic. Such a stop is wider and deeper than the capillary forming a “capillary jump” and thus the liquid's surface tension creates a lower force promoting flow of liquid. If the change in dimensions between the capillary and the wider stop is sufficient, then the liquid will stop at the entrance to the capillary stop. It has been found that the liquid will eventually creep along the hydrophilic walls of the stop, but by proper design of the shape this movement can be delayed sufficiently so that stop is effective, even though the walls are hydrophilic.

When a hydrophobic stop is located in a hydrophilic capillary, a pressure difference must be applied to overcome the effect of the hydrophobic stop. In general, pressure difference needed is a function of the surface tension of the liquid, the cosine of its contact angle with the hydrophilic capillary and the change in dimensions of the capillary. That is, a liquid having a high surface tension will require less force to overcome a hydrophobic stop than a liquid having a lower surface tension. A liquid which wets the walls of the hydrophilic capillary, i.e. it has a low contact angle, will require more force to overcome the hydrophobic stop than a liquid which has a higher contact angle. The smaller the hydrophobic channel, the greater the force which must be applied. This force can be generated by any means that allows a greater pressure before the stop than after the stop. In practice, a plunger pushing liquid into a port before the stop or pulling air out of a vent after the stop can provide the force to overcome the stop as effectively as applying a centrifugal force.

In order to design chips in which force is applied to overcome hydrophilic or hydrophobic stops empirical tests or computational flow simulation can be used to provide useful information enabling one to arrange the position of liquid-containing wells on chips and size the interconnecting capillary channels so that liquid sample can be moved as required by providing the needed force by adjusting the force applied.

Microfluidic devices can take many forms as needed for the analytical procedures which measure the analyte of interest. The microfluidic devices typically employ a system of capillary passageways connecting wells containing dry or liquid reagents or conditioning materials. Analytical procedures may include preparation of the metered sample by diluting the sample, prereacting the analyte to be ready it for subsequent reactions, removing interfering components, mixing reagents, lysising cells, capturing bio molecules, carrying out enzymatic reactions, or incubating for binding events, staining, or deposition. Such preparatory steps may be carried out before or during metering of the sample, or after metering but before carrying out reactions which provide a measure of the analyte.

Introducing Liquid Samples

In general, it is desirable that samples are introduced at the inlet port over a very short time, preferably only about one second. The passageways and chambers of a microfluidic chip will ordinarily be filled with air. The small samples, say 0.1 to 2 μL, must completely fill the passageways and chambers to assure that accurate results are obtained from contact of the samples with reagents. If the air is not purged completely from a chamber containing a reagent, only a partial response of the reagent will be obtained. The process begins with the inlet port and extends to the first chamber, which may be the inlet to a reaction chamber, as will be described in an example below.

Since a liquid sample may be introduced in several ways the actual shape of the opening in the inlet port may vary. The shape of the opening is not considered to be critical to the performance, since several shapes have be found to be satisfactory. For example, it may be merely a circular opening into which the sample is placed. Alternatively, the opening may be tapered to engage a corresponding shape in a pipette which deposits the sample. However, the fit should not be so tight that removing the application causes a negative pressure. In one embodiment, the opening is fitted with a plastic port which is designed to engage a specific type of pipette tip. Such ports could be open or closed so that nothing can enter the microfluidic chip until the port is engaged by the pipette. Depending on the carrier type, the sample may be introduced by a positive pressure, as when a plunger is used to force the sample into the inlet port. However, metering from a pipette is not required. Alternatively, the sample may be merely placed at the opening of the inlet port and capillary action used to pull the sample into the microfluidic chip. Also, the sample may be merely placed at the opening of the inlet port and vacuum used to pull the sample into the microfluidic chip. As has already been discussed, when the opening is small sufficient capillary forces are created by the interaction of the passage walls and the surface tension of the liquid. Typically, biological samples contain water and the walls of the inlet port and associated passageways will be hydrophilic so that the sample will be drawn into the microfluidic chip even in the absence of a positive pressure. However, it should be noted that a negative pressure at the inlet port is not desirable, since it may pull liquid out of the inlet chamber. Means should be provided to prevent a negative pressure from being developed during the introduction of the sample. Creating a positive pressure as by using a plunger to move the sample or providing a vent to atmosphere behind the sample liquid could be used for this purpose.

It has been found that the inlet passageway connecting the inlet opening and the first chamber may enter the first chamber through openings located at various positions in the chamber—providing that the liquid is uniformly distributed. FIG. 3 illustrates three possible routes which the inlet passageway may take. In FIG. 3a, the liquid passes through a capillary passageway at the bottom of the chip and enters the inlet chamber in an upwardly direction at the closest point to the inlet port. In FIG. 3b, the capillary passageway extends along the top of the chip and enters the chamber at the closest point. In a third possibility shown in FIG. 3c, the capillary passageway extends along the bottom of the chip, passes under the chamber and enters at the end opposite that used in FIG. 3a. In each case, it is important to include a means for distributing the liquid across the chamber uniformly. If the liquid is allowed to fill the chamber in a random manner it is possible that air may be trapped in the chamber and not completely purged. In such a case, the air is likely to affect the amount of liquid which is subsequently transferred into metering or reagent chambers. The accuracy of the analytical results obviously will be compromised.

It has been found that removing air uniformly is important to avoid formation of air bubbles which limit access of the liquid samples to reagents or which cause chambers to be less than full. Either result is undesirable. Flow restrictions can be used in the first sample well for example so that the liquid, as it enters from a capillary passageway from the inlet port, is spread uniformly across the sample well, pushing air out through the vent.

One type of flow restriction that has been found very satisfactory is a groove or a weir which extends across the inlet chamber between the inlet capillary and outlet vents for the air. The groove or weir may contain wedge-shaped polygon features or curved geometries spaced across the chamber to further assist the uniform distribution of the liquid. Alternatively, microstructures such as those described below can provide uniform distribution of a sample liquid over an inlet chamber. When the liquid is distributed by the means described, the pressure required upstream in the inlet capillary is greater, which also affects the movement of the liquid into the downstream passageway. It should also be mentioned that the inlet chamber may not always be empty. It may contain reagents and/or filters. For example, if the inlet chamber contains glass fibers for separating red blood cells from plasma, so that they do not interfere with the analysis of plasma, this step would be carried out before the feature controlling flow of the sample across the chamber is encountered. Blood anti-coagulants may be included in the inlet chamber.

In some microfluidic chips excess sample is transferred to an overflow chamber or well, in order to be sure that a sufficient amount of the sample liquid has been introduced for the intended analytical procedure. Where the sample is difficult to see easily, because of its color and/or small size, the overflow chamber may contain an indicator. By a change in color for example, when the sample enters the overflow chamber the indicator shows the person carrying out the analysis that the inlet chamber has been filled. One such indicator reagent is the use of a buffer and a pH indicator dye such that when the indicator reagent is wet the pH causes the dye to change color from its dry state. Many such color transition are known to those skilled in the art as well as reductive chemistries and elecro-chemical signals producing reaction.

Microstructures

The term “microstructures” as used herein relates to means for assuring that a microliter-sized liquid sample is uniformly contacted with a reagent or conditioning agent which is not liquid, but which has been immobilized on a substrate. Typically, the reagents will be liquids which have been coated on a porous support and dried. Distributing a liquid sample uniformly and at the same time purging air from the well can be done with various types of microstructures. Thus, they are also useful in the inlet chambers discussed above.

In one preferred microstructure, an array of posts is disposed so that the liquid has no opportunity to pass through the inlet chamber in a straight line. The liquid is constantly forced to change direction as it passes through the array of posts. At the same time, the dimensions of the spaces between the posts are small enough to produce capillary forces inducing flow of the liquid. Air is purged from the reagent area as the sample liquid surges through the array of posts. Each of the posts may contain one or more wedge-shaped cutouts which facilitate the movement of the liquid as discussed in U.S. Pat. No. 6,296,126. The wedge-shaped cutouts have a wedge angle of about 90 degrees or less and a radius of curvature at the wedge-edge smaller than 200 microns.

Other types of Microstructures which are useful include three dimensional post shape with cross sectional shapes that can be circles, stars, triangles, squares, pentagons, octagons, hexagons, heptagons, ellipses, crosses or rectangles or combinations. Microstructures with two dimensional shapes such as a ramp leading up to reagents on plateaus are also useful.

Applications

Microfluidic devices of the invention have many applications. Analyses may be carried out on samples of many biological fluids, including but not limited to blood, urine, water, saliva, spinal fluid, intestinal fluid, food, and blood plasma. Blood and urine are of particular interest. A sample of the fluid to be tested is deposited in the sample well and subsequently measured in one or more metering wells into the amount to be analyzed. The metered sample will be assayed for the analyte of interest, including for example a protein, a cell, a small organic molecule, or a metal. Examples of such proteins include albumin, HbAlc, protease, protease inhibitor, CRP, esterase and BNP. Cells which may be analyed include E.coli, pseudomonas, white blood cells, red blood cells, h.pylori, strep a, chlamdia, and mononucleosis. Metals which are to be detected include iron, manganese, sodium, potassium, lithium, calcium, and magnesium.

In many applications, color developed by the reaction of reagents with a sample is measured. It is also feasible to make electrical measurements of the sample, using electrodes positioned in the small wells in the chip. Examples of such analyses include electrochemical signal transducers based on amperometric, impedimetric, potentimetric detection methods. Examples include the detection of oxidative and reductive chemistries and the detection of binding events.

There are various reagent methods which could be used in chips of the invention. Reagents undergo changes whereby the intensity of the signal generated is proportional to the concentration of the analyte measured in the clinical specimen. These reagents contain indicator dyes, metals, enzymes, polymers, antibodies, electrochemically reactive ingredients and various other chemicals dried onto carriers. Carriers often used are papers, membranes or polymers with various sample uptake and transport properties. They can be introduced into the reagent wells in the chips of the invention to overcome the problems encountered in analyses using reagent strips.

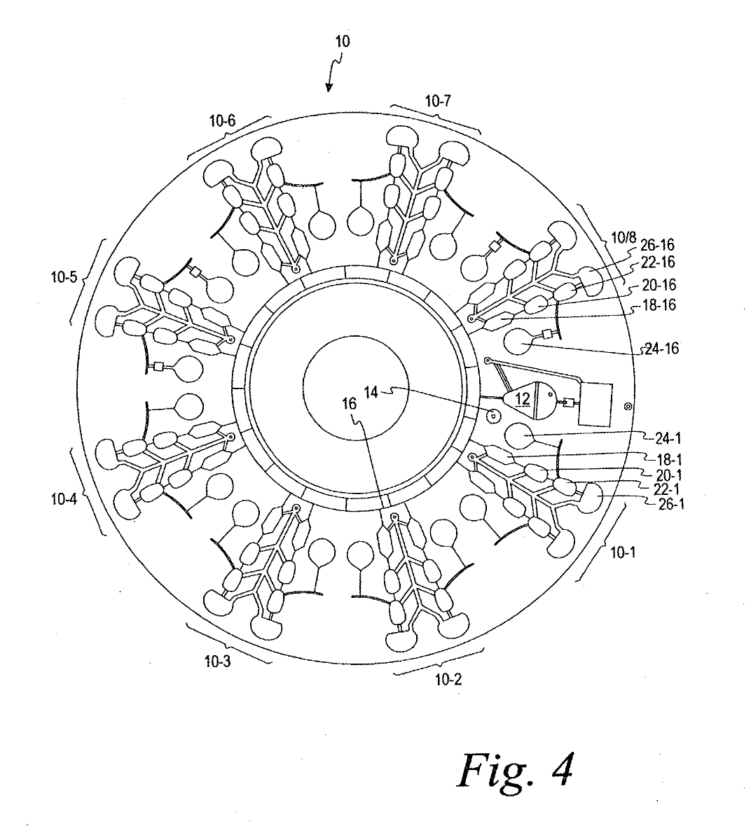

FIG. 4 shows a microfluidic disk 10 for use in analysis of urine for leukocytes, nitrite, urobilinogen, protein, albumin, creatinine, uristatin, calcium, oxalate, myoglobin, pH, blood, specific gravity, ketone, bilirubin and glucose. The disk contains sixteen parallel paths for analysis of urine samples. Each of the parallel paths is equally spaced as pairs in eight radial positions (10-1 to 10-8) and receives a sample distributed from a sample chamber 12 located in a ninth radial position. The sample is introduced through entry port 14. Each parallel path receives a portion of the sample through a capillary ring 16 and is vented through the center of the disk. The parallel paths may be described as follows: a capillary connecting to a metering chamber (18-1 to 18-16), connected via a capillary with a stop to a first reagent well (20-1 to 20-16), connected via another capillary with a stop to a second reagent well (22-1 to 22-16). The second reagent well is connected to a liquid reagent well (24-1 to 24-16) via a capillary with a stop and to a waste chamber (26-1 to 26-16) via a capillary with a stop. All chambers are vented to expel air. The chamber vents for two paths are gathered into a common shared vent and expelled to the bottom of the disk.

Separation steps are possible in which an analyte is reacted with reagent in a first well and then the reacted reagent is directed to a second well for further reaction. In addition a reagent can be re-suspensed in a first well and moved to a second well for a reaction. An analyte or reagent can be trapped in a first or second well and a determination of free versus bound reagent be made. A third liquid reagent can be used to wash materials trapped in the second well and to move materials to the waste chamber.

The determination of a free versus bound reagent is particularly useful for multizone immunoassay and nucleic acid assays. There are various types of multizone immunoassays that could be adapted to this device. In the case of adaption of immunochromatography assays, reagents filters are placed into separate wells and do not have to be in physical contact as chromatographic forces are not in play. Immunoassays or DNA assay can be developed for detection of bacteria such as Gram negative species (e.g. E. Coli, Entereobacter, Pseudomonas, Klebsiella) and Gram positive species (e.g. Staphylococcus Aureus, Entereococc). Immunoassays can be developed for complete panels of proteins and peptides such as albumin, hemoglobin, myoglobulin, α-1-microglobulin, immunoglobulins, enzymes, glyoproteins, protease inhibitors, drugs and cytokines. See, for examples: Greenquist in U.S. Pat. No. 4,806,311, Multizone analytical Element Having Labeled Reagent Concentration Zone, Feb. 21, 1989, Liotta in U.S. Pat. No. 4,446,232, Enzyme Immunoassay with Two-Zoned Device Having Bound Antigens, May 1, 1984.

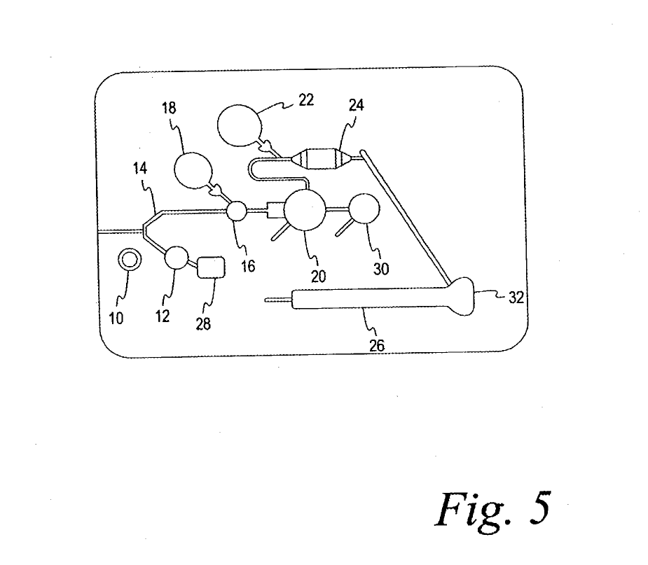

One microfluidic chip that can be used for immunoassays is illustrated in FIG. 5. A sample is deposited in sample port 10, from which it passes by capillary action to prechamber 12 containing a weir or groove to assure complete purging of air. Then the liquid enters metering capillary 14. A denaturant/oxidizing liquid is contained in well 18. A mixing chamber 20 provides space and microstructures for mixing the blood sample with the liquid from well 18. Well 22 contains a wash solution which is added to the mixed liquid flowing out of well 20. Chamber 24 contains an array of posts for providing uniform contact of the preconditioned sample with labeled monoclonal antibodies disposed on a dry substrate. Contact of the labeled sample with an agglutination, which is disposed on a substrate is carried out in chamber 26, producing a color which is measured to determine the amount of glycated hemoglobin in the sample. The remaining wells provide space for excess sample (28), excess denatured sample (30), and for a wicking material (32) used to draw the sample over the substrate in chamber 26.

Potential applications where dried reagents are resolubilized include, filtration, sedimentation analysis, cell lysis, cell sorting (mass differences) and centrifugal separation. Enrichment (concentration) of sample analyte on a solid phase (e.g. microbeads) can be used to improved sensitivity. The enriched microbeads could be separated by continuous centrifugation. Multiplexing can be used (e.g. metering of a variety of reagent chambers in parallel and/or in sequence) allowing multiple channels, each producing a defined discrete result. Multiplexing can be done by a capillary array compromising a multiplicity of metering capillary loops, fluidly connected with the entry port, or an array of dosing channels and/or capillary stops connected to each of the metering capillary loops. Combination with secondary forces such as magnetic forces can be used in the chip design. Particle such as magnetic beads used as a carrier for reagents or for capturing of sample constituents such as analytes or interfering substances. Separation of particles by physical properties such as density (analog to split fractionation).

### EXAMPLE 1

In a test chip similar to that of FIG. 3c, the geometry of inlet port opening was varied to demonstrate that the shape of the opening was not critical to filling the inlet chamber. The results of these tests are given in the following table:

| | Depth | Width | Length | | | |
|---|---|---|---|---|---|---|
| Geometry | mm | mm | mm | Sample | Fluid Force | Fill time |
| Rectangle | 0.03 | 0.150 | 1.0 | Whole blood | Capillary | <1 sec |
| Cylinder | 0.100 | 0.100 | 1.0 | Whole blood | Capillary | <1 sec |
| Rectangle | 0.03 | 0.150 | 2.0 | Whole blood | Capillary | <2 sec |
| Rectangle | 0.03 | 0.150 | 2.0 | Urine | Capillary | <1 sec |
| Rectangle | 0.03 | 0.150 | 2.0 | Urine | Positive | <1 sec |
| with | | | | | pressure | |
| adapter | | | | | | |
| Rectangle | 0.03 | 0.150 | 2.0 | Whole blood | Positive | <1 sec |
| with | | | | | pressure | |
| adapter | | | | | | |
| Rectangle | 0.03 | 0.150 | 2.0 | Whole blood | Negative | <2 sec |
| with | | | | | pressure | |
| adapter | | | | | | |

Using a capillary as the inlet port, the inlet chamber was filled in the less than 2 seconds with and without an adapter at the inlet. The fill time was dependent on the fluid used as well as the surface energy of the capillary and the length, width or shape of the capillary.

### EXAMPLE 2

Using a test chip similar to that of Example 1, the pressure and volumes used to add fluid to the inlet chamber via the port opening were varied. The inlet chamber volume was 5 μL and a metering loop having a volume of 0.3 μL received liquid when the inlet chamber was filled. The experiment was performed with blood and urine.

| Volume (μL) | Sample delivery device | Pressure | Observation |
|---|---|---|---|
| 5 | Capillary with out plunger | Target | Metering occurs |
| 4 | Capillary with out plunger | Target | Metering occurs |
| 6 | Capillary with out plunger | Target | Metering occurs & |
| | | | excess overflows |
| 5 | Capillary with plunger | High | Metering occurs |
| 4 | Capillary with plunger | High | Metering occurs |
| 6 | Capillary with plunger | High | Metering occurs & |
| | | | excess overflows |
| 5 | Capillary with plunger | Low | Metering occurs |
| 4 | Capillary with plunger | Low | Metering occurs |
| 6 | Capillary with plunger | Low | Metering occurs & |
| | | | excess overflows |

Pressure applied either by capillary action or by use of a plunger allowed acceptable filling over a wide range of sample volumes 4-6 μL. In the case of an over fill, the excess fluid exits through the inlet chamber vent. An overflow chamber is therefore desirable to receive excess sample. This chamber would fill when the metering loop is completely filled and excess sample overflows.

### EXAMPLE 3

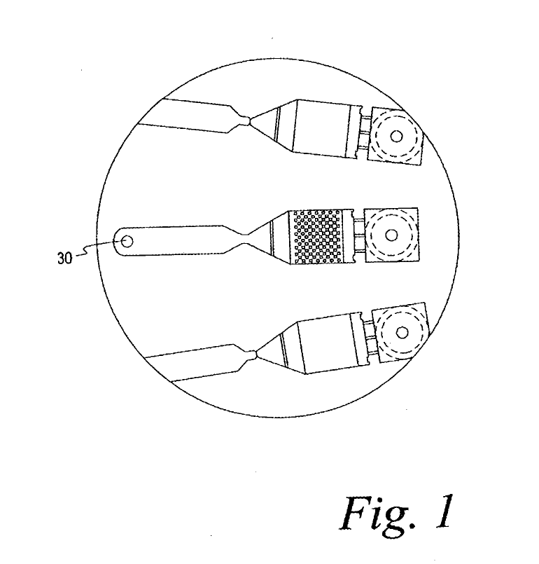

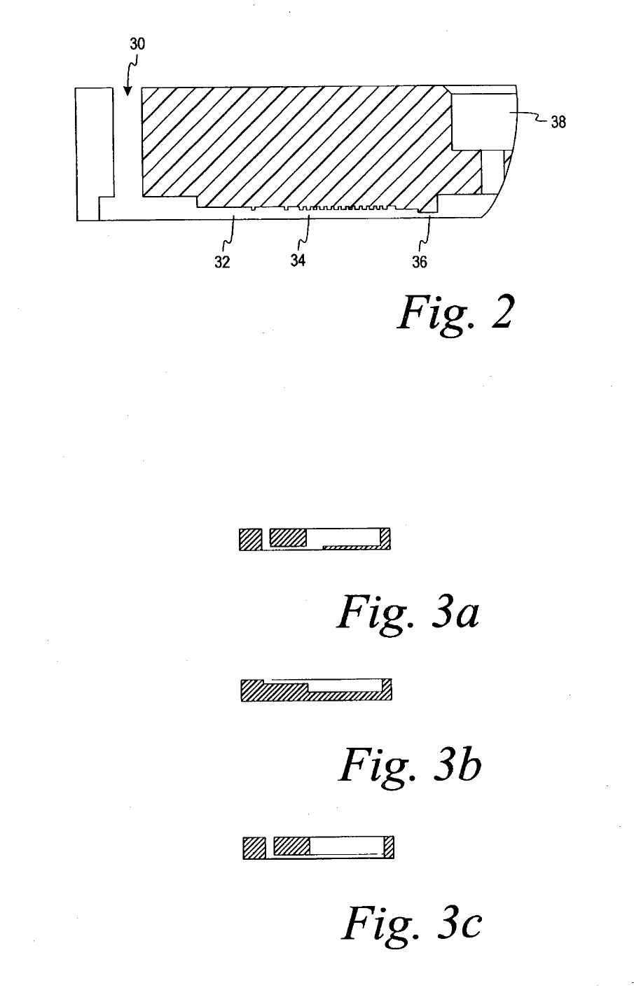

The microfluidic device of FIGS. 1 and 2 was used to measure the glucose content of blood. Whole blood pretreated with heparin was incubated at 250° C. to degrade glucose naturally occurring in the blood sample. The blood was spiked with 0, 50, 100, 200, 400, and 600 mg/μL of glucose as assayed on the YSI glucose instrument (YSI Instruments Inc.). A glucose reagent (chromagenic glucose) reagent as described in Bell U.S. Pat. No. 5,360,595 was coated on a nylon membrane disposed on a plastic substrate. A sample of the reagent was placed in chamber 34 and the bottom of the device covered with Excel Scalplate (Excel Scientific Inc.).

Samples of blood containing one of the concentrations of glucose were introduced into inlet port 30 using a 2 μL capillary with plunger (Drummond Aqua). Since the inlet port is sealed when the sample is dispensed, a positive pressure is established which forces the sample into the inlet passageway 32 and then into the reagent area 34. The sample reacted with the reagent to provide a color change, which is then read on a spectrometer at 680 nm, as corrected against a black and white standard.

Two plastic substrates, PES and PET, were used with the series of blood samples. Where PET coated with reagent were used, a 500 nm to 950 nm transmittance meter was used to read the reaction with the sample. Where PES coated with reagent was used a bottom read reflectance meter was used to read the reaction with the sample.

The results are compared with a conventional procedure, YSI results. Comparable results were obtained, as can be seen in the following table.

TABLE 2

| Expected | Observed |
|---|---|
| Glucose | Glucose (n = 6) |
| 0 | 0.3 |
| 50 | 48.5 |
| 100 | 103.1 |
| 200 | 197.3 |
| 400 | 409.1 |
| 600 | 586.7 |

What is claimed is:

1. A microfluidic device for assaying a liquid biological sample of 20 μL or less comprising:
(a) an inlet port for receiving said sample;
(b) a capillary passageway in fluid communication with said inlet port;
(c) an inlet chamber in fluid communication with the capillary passageway of (b), thereby permitting said sample to flow into said inlet chamber, said inlet chamber containing means for uniformly distributing said sample across said chamber and, displacing air from said chamber; and
(d) at least one vent passageway for removing air displaced by said liquid sample.

2. A microfluidic device of claim 1 wherein said means for uniformly distributing said sample is at least one groove extending across said inlet chamber.

3. A microfluidic device of claim 1 wherein said means for uniformly distributing said sample is at least one weir extending across said inlet chamber.

4. A microfluidic device of claim 2 or 3 wherein said at least one groove or at least one weir contains wedge-shaped cutouts to facilitate uniform flow of said sample.

5. A microfluidic device of claim 1 wherein said means for uniformly distributing said sample is a microstructure comprising an array of posts disposed across said inlet chamber.

6. A microfluidic device of claim 5 wherein said posts contain wedge-shaped cutouts to facilitate uniform flow of said sample.

7. A microfluidic device of claim I wherein said inlet port is tapered to engage the corresponding shape of a pipette for depositing said sample

8. A microfluidic device of claim 1 further comprising an blood anti-coagulant deposited in said inlet chamber.

9. A microfluidic device of claim 1 further comprising an overflow chamber in fluid communication with said inlet chamber, said overflow chamber for receiving said sample in excess of the amount needed to fill said inlet chamber.

10. A microfluidic device of claim 9 wherein said overflow chamber contains an indicator to detect the presence of excess of said sample.

11. A method of supplying liquid to a microfluidic device having an inlet port in fluid communication with an inlet chamber via a capillary passageway, said method comprising.
(a) introducing a portion of said liquid into said inlet port;
(b) transferring by positive pressure or capillary forces said liquid portion of (a) to said inlet chamber via said capillary passageway;
(c) distributing said liquid portion of (a) uniformly across said inlet chamber and purging air from said chamber completely.

12. A method of claim 11 wherein excess of said sample is diverted to an overflow chamber after said inlet chamber is filled.

13. A method of claim 12 wherein the presence of said excess is detected by an indicator in said overflow chamber.
